(19) United States
(12) Patent Application Publication
(10) Pub. No.: US 2006/0136943 A1
(43) Pub. Date: Jun. 22, 2006

(54) Device for writing on sequential CDRS

(76) Inventor: Steve Price, Carlsbad, CA (US)

Correspondence Address: NEIL K. NYDEGGER;NYDEGGER & ASSOCIATES, 348 Olive Street, San Diego, CA, 92103, US

(21) Appl. No.: 11/017,441

(22) Filed: Dec. 20, 2004

(51) Int. Cl. G11B 17/04

(52) U.S. Cl. 720/619; 720/620

(57) ABSTRACT

A data transfer module receives data from a memory device such as a camera and transfers the data onto a laser optical disk. The data transfer module is provided with a stack of laser optical disks from which single disks may be sequentially released to a disk-writing drive where the data from the memory device is written onto the released disk to create a written disk. After the data transfer is completed, the module ejects the written disk.

### FIELD OF THE INVENTION

The present invention pertains generally to devices and methods for transferring digital data to optical disks. More particularly, the present invention pertains to data transfer modules that receive data and write the data onto disks that are dispensed from a stored stack of disks. The present invention is particularly, but not exclusively, useful for receiving image data from digital cameras and writing the data onto a desired number of disks.

### BACKGROUND OF THE INVENTION

Digital cameras are rapidly replacing conventional cameras in both professional and recreational use. A major benefit provided by digital camera technology is the use of camera memory instead of conventional camera film. While conventional cameras typically limit a photographer to twenty-four or thirty-six photographs before requiring new film, digital camera memory allows hundreds of photographic images to be taken and stored. Nevertheless, digital camera memory is finite and requires that the images stored by the camera eventually be erased or transferred to another storage unit to allow the camera to take and store new images.

Due to their storage capacities and ease of use, writable digital optical disks are currently the most widely used portable storage units. Coupled with the prevalence of digital cameras, disks are replacing photo albums as the most popular way of compiling, saving and sharing photographic images.

Transferring images from a digital camera to an optical disk, however, requires use of a computer system. Typically, such systems must include software that downloads image data from the camera as well as a disk drive that writes the image data onto disks. In addition to the required equipment, a certain level of skill and comfort with computer use is needed. While some digital photographers may possess or acquire the necessary equipment and sufficient familiarity with computers to transfer images from their camera to a disk at home or work, others may prefer to have a third party transfer the images for them, whether for reasons of finances, time or simplicity. Therefore, there is a need for a device that automatically writes digital image data from a camera onto an optical disk. A device that satisfies this need while facilitating consumer use would be well received by many digital camera users.

In light of the above, it is an object of the present invention to provide a data transfer module that automatically transfers image data from digital cameras to optical disks. It is another object of the present invention to provide a module that automatically transfers data to any desired number of disks. Another object of the present invention is to provide a system and method that allows a user to connect a camera to a data transfer module and to receive a disk holding the data while requiring minimal oversight. Still another object of the present invention is to provide a device for transferring data onto disks and a method for using the device, wherein the device is relatively easy to manufacture, simple to use and is comparatively cost effective.

### SUMMARY OF THE INVENTION

In accordance with the present invention, a data transfer module (i.e. kiosk) includes a mechanism for receiving and holding a cartridge containing a plurality of blank, optical laser disks (e.g. a stack of twenty-five or more disks). The module also includes a storage unit for storing digital data received through an input port, and it has a disk-writing drive for transferring data from the storage unit onto a blank disk. Additionally, a dispenser is mounted on the module. More specifically, the dispenser can be selectively activated to sequentially release individual blank disks from the cartridge for transfer to the disk-writing drive, where a written disk can be created. An ejector, also mounted on the module, then retrieves the written disk and ejects it from the module. Further, a control system is provided that controls the operation of the module.

In the preferred embodiment of the present invention, the dispenser includes four identical levers that support the stack of blank disks in the cartridge. Individually, each lever comprises a support plate and a retain plate, with each plate having two apertures that are spaced apart from one another. These apertures may be aligned when the support plate and retain plate are juxtaposed. When so aligned, a pivot pin is positioned in one pair of the aligned apertures and an actuator pin is positioned in the other pair of the aligned apertures such that the support and retain plates are held together. Further, each plate includes a cammed end portion that extends out from the periphery of the other plate.

In addition to the levers, the dispenser includes a substantially circular base plate and a substantially circular actuator ring. The base plate and actuator ring are annular and concentrically aligned to form an opening through which disks pass when they are dispensed from the cartridge. Each pivot pin is mounted on the base plate, and each actuator pin is connected to the actuator ring. In the combination, the cammed ends of the plates extend toward the opening. When assembled, the base plate, support plate and retain plate are connected to one another by the pivot pin. Similarly, the support plate, retain plate and actuator ring are connected to one another by the actuator ring. As a result, rotary movement by the actuator ring with respect to the base plate causes each lever to simultaneously pivot about its pivot pin. Preferably, the dispenser is provided with a lever actuator for providing such rotary movement to the actuator ring.

For the preferred embodiment of the present invention, the ejector includes a transport that has a platform for supporting a written disk after it is carried out of the disk-writing drive. A shaft connects this platform to a magnetic member that is received in a chamber, and surrounded by a conductive coil. Also included in the chamber is a viscous liquid (e.g., oil) for dampening movement of the magnetic member with respect to the chamber. In addition to the transport, the ejector includes a pair of conveyor grips for engaging a written disk and ejecting it from the module. Specifically, the grips are located in a same plane, and are connected to a conveyor mechanism. More specifically, the conveyor mechanism operates the grips to move them substantially parallel to each other, in a same planar direction. Further, the conveyer grips are connected to a grip actuator that pivots the grips toward and away from one another in the plane.

In operation of the present invention, data is received from a memory device through the input port and is stored in the storage unit. After the data is received, the dispenser is activated to dispense a blank disk from the stack of disks in the cartridge. Specifically, the lever actuator rotates the actuator ring with respect to the base plate causing the levers to be moved from a “support” orientation to a “release” orientation. In the support orientation, the levers support an “n” number of disks with the cammed ends of the support plates. In the release orientation, the levers support an “n-1” number of disks with the cammed ends of the retain plates. Therefore, movement of the levers from the support orientation to the release orientation causes a single disk to be dispensed from the stack.

After being dispensed from the stack, the released disk is received on a drive tray having a central void. The drive tray then carries the disk into the disk-writing drive where data is written from the storage unit onto the disk. Once the data is written onto the disk, the drive tray carries the written disk out of the drive. Next, an electric current is passed through the coil that is surrounding the chamber to cause the magnetic member and platform to move with respect to the chamber. As a result, the platform extends from the chamber and passes through the central void of the drive tray to carry the written disk to a position between the conveyor grips. When the written disk is located between the conveyor grips it is said to be at the “removed” position.

Because the conveyor grips are initially spaced apart from one another by a distance greater than the diameter of the disk, the platform is able to carry the written disk to the removed position without contacting the grips. Once the written disk reaches the removed position, the grip actuator moves the conveyer grips toward one another until they engage the disk at diametrically opposed sides of the disk. After the disk is engaged by the grips, the conveyor mechanism moves the grips in parallel until the disk travels beyond the end of the conveyer grips and passes out of the module through a slot in the module housing.

In order to transfer data onto another disk, the dispenser's levers are moved back to the support orientation, the platform of the transport is retracted, and the conveyor grips are moved away from one another until they are separated by a distance greater than the diameter of the disk. Once these steps are performed, the components of the data transfer module are in position to repeat the previously discussed operation steps to transfer data onto another disk.

While certain embodiments are described above, other alternate embodiments are contemplated by the present invention. For instance, it may be desired to write data directly from the external memory device to a disk without storing the data in the module's storage device. In such cases, the port is connected directly to the disk-writing drive to provide this capability.

In addition, in certain circumstances, the module may, be called on to receive data from multiple external memory devices, compile the data, and write the data onto a single disk. In such circumstances, the port receives the data from the multiple sources sequentially and the storage device holds and communicates the data to the disk-writing drive as if it were received from a single memory device.

In other circumstances, particularly when a single disk cannot hold all of the desired data, the module may be called on to divide the data into smaller groups and to write the groups of data onto successive disks. Division of the data can be performed in the storage unit at the direction of the user or by the control system. After the groups of data are selected, they are transferred onto successive disks.

Furthermore, it is noted that, while components herein are specifically described, such specific descriptions are not intended to be limiting. For example, the dispenser in the present invention is described herein as having four levers. In certain situations fewer or more levers may be desired. As another example, the levers are described as including juxtaposed support plates and retain plates. In certain embodiments, the levers may be single integral pieces including the plates and/or pins.

In accordance with another embodiment of the present invention, a method is provided for automatically writing digital data onto a blank disk dispensed from a stack of disks. Preferably, the steps of the method include positioning the disks in a cartridge connected to a data transfer module and activating the module. Upon activation, the module sequentially dispenses each disk from the cartridge, writes the data onto each disk, and ejects each disk after the data is written thereon. As discussed above, the module includes the components that perform the automated steps in this method.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an embodiment of the data transfer module (kiosk) of the present invention;

FIG. 2 is a side cross-sectional view of the data transfer module as seen along the line 2-2 in FIG. 1 with a disk shown in the removed position;

FIG. 3 is a top view of the component elements of the dispenser of the data transfer module as seen along the line 3-3 in FIG. 1;

FIG. 4 is a top view of a retain component element of a lever;

FIG. 5 is a top view of a support component element of a lever;

FIG. 6 is an exploded plan view of combined component elements of the lever;

FIG. 7A is a top view of component elements (FIGS. 5 and 6) of the lever shown in the support orientation with portions shown in phantom for clarity;

FIG. 7B is a top view of the combined component elements (FIGS. 5 and 6) of the lever shown in the release orientation with portions shown in phantom for clarity;

FIG. 8A is a side cross-sectional view of the dispenser shown in the support orientation;

FIG. 8B is a side cross-sectional view of the dispenser shown in the release orientation.

FIG. 9 is a side cross-sectional view of the component elements of the transport shown with its platform extended;

FIG. 10 is a side cross-sectional view of the component elements of the transport shown with its platform retracted;

FIG. 11A is a top view of the component elements of the grip conveyors shown before engaging the disk; and

FIG. 11B is a top view of the component elements of the grip conveyors shown engaging the disk.

### DESCRIPTION OF THE PREFERRED EMBODIMENTS

Referring initially to FIG. 1, a data transfer module in accordance with the present invention is shown and generally designated 20. As shown, the module 20 is in the form of a stand-alone kiosk that may be placed in a shopping mall, market, convenience store, or even drive-through lane. The module 20 allows a user to quickly transfer desired image data from a digital memory device 22 such as a digital camera, cell phone, digital memory card, or the like to an optical disk 24 without investing time or money on computer equipment and/or knowledge that may otherwise be unneeded.

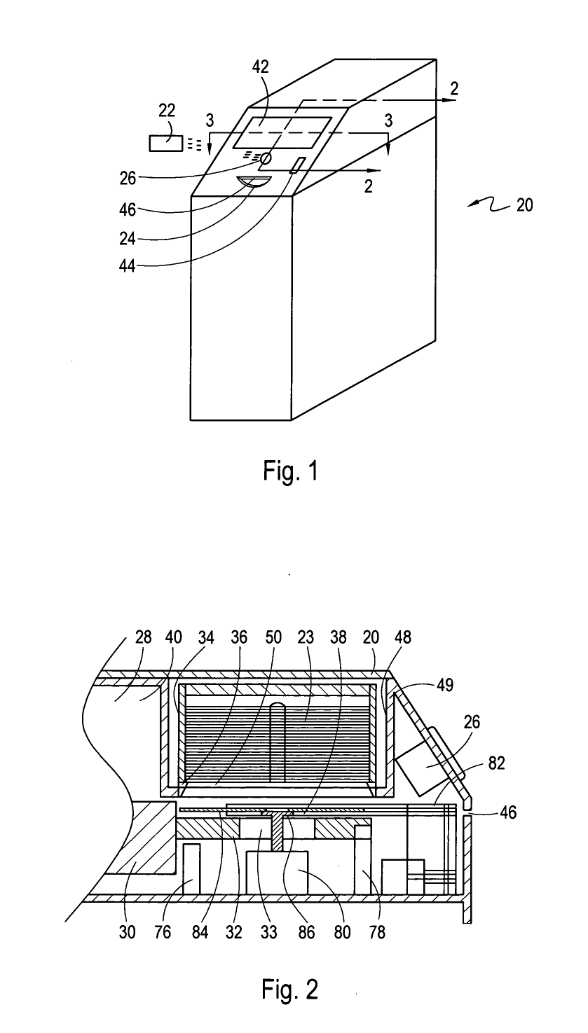

In FIGS. I and 2, the module 20 is shown to include an input port 26 that communicates with the memory device 22. The memory device 22, in turn, is connected to a storage unit 28 that stores the data received through the port 26. Also provided is a disk-writing drive 30 that writes the data in the storage unit 28 onto blank disks 24. As shown, a disk tray 32 having a central void 33 is included for carrying a disk 24 into and out of the drive 30. Also shown is a cartridge 34 that holds a stack 23 of blank disks 24 which are engaged by a dispenser 36 to sequentially release single blank disks 24 from the cartridge 34 to the tray 32. Further, FIGS. 1 and 2 show an ejector 38 that receives finished written disks 24 from the tray 32 and ejects the finished disks 24 from the module 20. Preferably, a control system 40 controls operation of the foregoing module components. As shown in FIG. 1, connection between the input port 26 and the memory device 22 may be via a non-physical connection as is utilized in infrared and “Bluetooth” technology; however, the port 26 also may provide for wire connection.

Also provided on the module 20 is an input screen 42 that prompts the user to provide information necessary for the data transfer. For providing a preview of the images from the memory device 22, the screen 42 may be a typical cathode-ray-tube screen. Alternatively, the screen 42 may include a touch screen that receives input through strain gage, optical or electrostatic technology or the like. In such cases, the input screen 42 may, in addition to previewing the camera images for the user, request information from the user such as which images to transfer and how many disks 24 are desired. Furthermore, the input screen 42 may communicate error signals, fee information, and other instructions to the user.

To receive payment from the user, the module 20 includes a payment collection device 44 which may include a swipe strip for use with credit or debit cards and/or a cash-reading device such as those used in vending machines. Upon payment of the required fee, the module 20 transfers the selected image data to the desired number of disks 24 and ejects the finished written disks 24 through a slot 46.

During operation of the module 20, the control system 40 communicates data received by the port 26 to the drive 30, or to the internal data storage device 28. As envisioned for the present invention, the storage device 28 may be a direct access storage device (DASD), a magnetic storage diskette (floppy disk), a Zip disk, magnetic tape, random access memory (RAM), electronic read-only memory (e.g., ROM, EPROM, or EEPROM), or the like. Once data is received in the storage device 28, it may be communicated to the input screen 42 to allow the user to input preferences as discussed above. These preferences are stored with the data in the storage device 28 pending the instruction to begin transfer of data to a disk 24.

Referring still to FIG. 2, the disks 24 are stored in a stack 23 in the removable cartridge 34. Receiving the stack 23 is a cylindrical channel 48 formed by an internal wall 49 of the module 20. As shown, the release end 50 of the cartridge 34 is open, allowing disks 24 to be released from the cartridge 34 into the module 20.

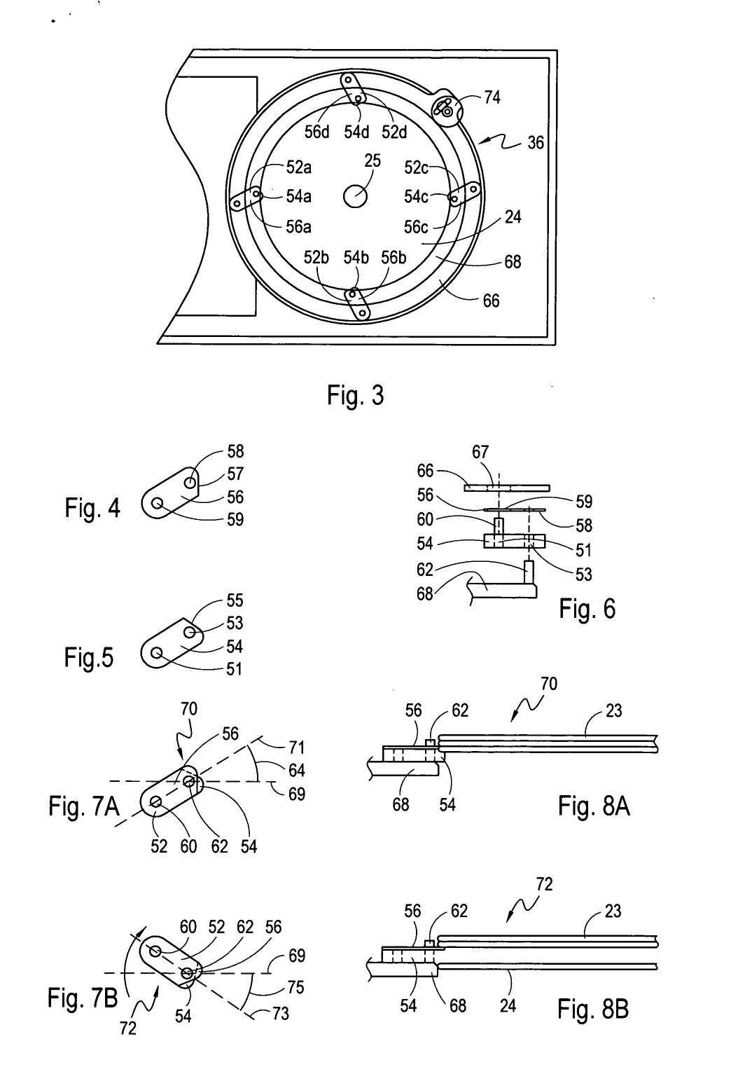

Positioned at the base of the cartridge 34 is the dispenser 36 that engages and sequentially dispenses the disks 24. As shown in FIG. 3, the dispenser 36 preferably includes a plurality of levers 52, of which the levers 52a-d are exemplary. Together, the levers 52 support the stack of disks 24 in the cartridge 34. Preferably, each lever 52 includes a support plate 54 and a retain plate 56, as shown by exemplary support plates 54a-d and retain plates 56a-d. Referring to FIGS. 4 and 5, the support plates 54 and retain plates 56 are shown having oppositely facing cammed ends 55, 57. For use as a lever 52 in the present invention, a retain plate 56 is placed on top of a support plate 54 as shown in FIG. 6. When juxtaposed in this way, the cammed end 55 of the support plate 54 extends out from underneath the retain plate 56. To ensure this alignment, the support plate 54 and retain plate 56 are held together by an actuator pin 60 and a pivot pin 62. The actuator pin 60 passes through aperture 51 of support plate 54 and through aperture 59 of retain plate 56, while the pivot pin 62 passes through aperture 53 of support plate 54 and through aperture 58 of retain plate 56. For operational purposes of the present invention, the actuator pin 60 is mounted in an aperture 67 in an actuator ring 66 and the pivot pin 62 is connected to a base plate 68 (also shown in FIG. 2). Movement of the actuator ring 66 with respect to the base plate 68 causes pivoting of the lever 52 as is discussed below.

FIGS. 3, 7A and 8A show a lever 52 in the support orientation 70 in which the support plate 54 supports an “n” number of disks 24. As shown, the retain plate 56 is outside the footprint of the disks 24 and provides no support to the disks 24 in the support orientation 70. In FIG. 7A, the axis 71 of lever 52 is shown forming an angle 64 with respect to a reference axis 69 at which the actuator pin 60, pivot pin 62 and center 25 of the disk 24 form a line. Upon clockwise movement of the actuator ring 66 (as indicated by the arrow in FIG. 7B), the actuator pin 60 pivots the lever 52 about the pivot pin 62 (which is mounted on the non-moving base plate 68). As a result of this movement, the axis 73 of the lever 52 forms an angle 75 with the reference axis 69. Angle 75 is preferably equal to angle 64. When lever 52 is pivoted as in FIGS. 7B and 8B, the retain plates 56 are inserted into the footprint of the disks 24 above the bottom-most disk 24 to support an “n-1” number of disks 24 and the support plates 54 are simultaneously withdrawn from the footprint of the disks 24 to allow the bottom-most disk 24 to fall from the dispenser 36. In order to allow the insertion of the retain plates 56 into the stack of disks 24, the retain plates 56 are thinner than the disks 24 and preferably have a thickness of less than about 1/32 inches. FIGS. 7B and 8B depict a lever 52 after it has been moved to the release orientation 72 to release a single disk 24 from the stack 23 of disks 24. As can be understood from FIGS. 8A and 8B, the levers 52 may be returned to the support orientation 70 from the release orientation 72 without any further release of disks 24 since the new bottom-most disk 24 cannot fall past the support plate 54 from the retain plate 56.

Also shown in FIG. 3 is a lever actuator mechanism 74 that drives the clockwise movement of the actuator ring 66 from the support orientation 70 to the release orientation 72 and the subsequent counterclockwise movement back to the support orientation 70. As envisioned by the present invention, the actuator mechanism 74 may be any known motor or other device for providing rotational movement to the actuator ring 66 relative to the base plate 68.

Referring back to FIG. 2, the dispenser 36 releases disks 24 from the cartridge 34 to the disk tray 32. While the disk tray 32 is shown open and ready to receive a disk 24, a tray-in sensor 76 and tray-out sensor 78 are provided to facilitate proper delivery of the disks 24 to the tray 32. During operation, these sensors 76, 78 provide a signal to the controller 40 and the controller 40 ensures that the tray 32 is in position to receive a disk 24 from the dispenser 36 before the dispensing action is commenced. After receiving a disk 24 from the dispenser 36, the tray 32 carries the disk 24 into the drive 30 where the transfer of data from the storage device 28 or memory device 22 to the disk 24 is performed by writing onto or “burning” the disk 24. To enable the data transfer, the drive 30 is electronically connected to the controller 40, storage device 28 and/or port 26.

After the data transfer is completed, the tray 32 carries the disk 24 out of the drive 30. Then, an ejector 38 receives the disk 24 and ejects it from the module 20 through the slot 46. As shown in FIG. 2, the ejector 38 includes a transport 80 and conveyor grips 82. During operation, the transport 80 passes through the central void 33 and removes the disks 24 from the disk tray 32 by transporting the disks 24 to the removed position 84 that is between the conveyor grips 82.

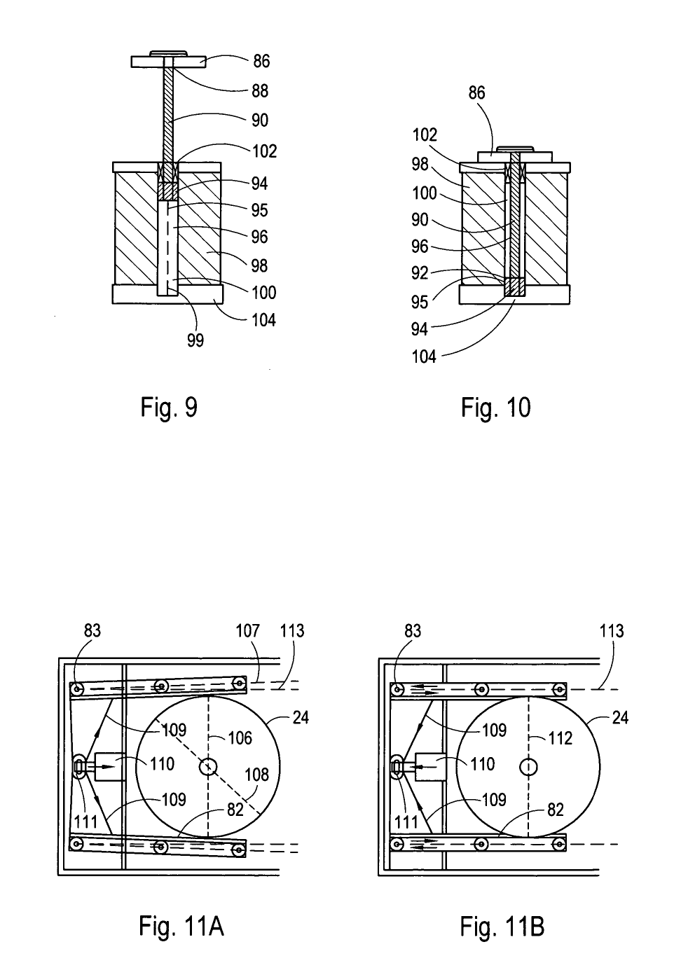

As shown in FIGS. 9 and 10, the transport 80 includes a platform 86 that is connected to an end 88 of a shaft 90. A magnetic member 94, preferably a rare earth magnet, is mounted to end 92 of the shaft 90. The magnetic member 94 is received within a chamber 96 that is surrounded by a conductive coil 98. To dampen movement of the magnetic member 94 within the chamber 96 and, therefore, movement of the platform 86, the remainder of the chamber 96 is filled with viscous oil 100. FIGS. 9 and 10 show the magnetic member 94 having a passageway 95 to allow the viscous oil 100 to pass therethrough. While this construction is merely exemplary, it is shown to portray the dampening effect of the viscous oil 100 on movement of the magnetic member 94 within the chamber 96. As further shown in FIGS. 9 and 10, the chamber 96 includes a seal 102 and a mounting base 104 which enclose the magnetic member 94 and viscous oil 100. Preferably, the mounting base 104 is mounted to the data transfer module 20.

Operation of the transport 80 is controlled by passing an electric current through the conductive coil 98. As is known from Faraday's Law, directing an electric current through a coil creates an induced electromagnetic force along the axis of the coil. Therefore, when a current is passed through the coil 98 in the clockwise direction (as viewed from the top of the transports 80 shown in FIGS. 9 and 10), an induced electromagnetic force is created along axis 99 and the magnetic member 94 is urged to move toward the seal 102 or base 104 (depending on the orientation of the magnetic member 94). Likewise, directing the current through the coil 98 in the counterclockwise direction will cause the magnetic member 94 to move in the opposite direction. Therefore, movement of the platform 86 from the retracted position shown in FIG. 10 to the extended position shown in FIG. 9 (and vice versa) may be manipulated by controlling the direction of the electric current through the conductive coil 98.

As the platform 86 is extended from the chamber 96, it passes through a void in the disk tray 32 and carries any disk 24 held by the tray 32 to the removed position 84 shown in FIG. 2. While in the removed position 84, the disk 24 is positioned between the pair of conveyor grips 82. As shown in FIG. 11A, the conveyer grips 82 are initially set such that the distance 106 between the grips 82 is greater than the diameter 108 of the disk 24 so that the grips 82 do not engage the disk 24. This arrangement allows the transport 80 to position the disk 24 between the grips 82. A grip actuator 110 is used to position the grips 82 apart by distance 106.

Specifically, actuator 110 is mounted to the module 20 and is positioned between the grips 82. Actuator 110 includes an actuator head 111 that is extendible from, and retractable into, actuator 110. In addition, actuator 110 includes actuator arms 109 that are connected to the actuator head 111 and to the conveyor grips 82. When actuator head 111 is retracted into actuator 110, arms 109 force grips 82 apart (as shown by arrows along arms 109) about pivot 83 until distance 106 is provided between grips 82. In this orientation, the conveyer grips 82 form a grip axis 107.

In order to eject the disk 24 from the module 20, the grip actuator 110 forces the grips 82 toward one another to engage the disk 24 by extending actuator head 111 from actuator 110 which results in the arms 109 pulling the grips 82 toward one another about pivots 83. As shown in FIG. 11B, after this pivoting of the grips 82 about pivots 83, the grips 82 are aligned substantially parallel along grip axes 113 and are spaced apart by a distance 112 which is equal to (or slightly less than) the diameter 108 of the disk 24. The distance 112 between the grips 82 may be slightly less than the diameter 108 of the disk 24 if the disk 24 is slightly bowed by the pressure exerted by the grips 82. Once the disk 24 is grasped by the conveyor grips 82, the grips 82 are activated to move the disk 24 out of the data transfer module 20 through the slot 46. Activation of the grips 82 to provide this translational movement of the disk 24 is controlled by the grip actuator 110.

In use, the present invention described above allows a user to quickly and easily transfer desired image data from a memory device 22 to an optical disk 24. Initially, the user is prompted by the module 20 to connect the memory device 22 to the input port 26. Automatically, the module 20 downloads the memory device's image data to the storage device 28 and requests that the user select the images to transfer and the number of disks desired on the input screen 42. After receiving this information, the module 20 calculates the required fee and requests payment from the user in the form of credit, debit or cash via the collection device 44. Upon payment, the module 20 begins the process of writing the image data onto the desired number of disks 24 as described below.

First, the tray sensors 76, 78 determine whether the tray 32 is ready to receive a disk 24 and, if not, the control system 40 opens the tray 32. Then, the dispenser 36 is activated and the levers 52 are moved from the support orientation 70 to the release orientation 72 to dispense a single disk 24 from the cartridge 34 to the tray 32. After receiving the disk 24, the tray 32 closes and the drive 30 begins writing the data from the storage device 28 onto the disk 24. After the data transfer is completed, the tray 32 opens. When the sensors 76, 78 recognize that the tray 32 is open, the transport 80 is activated and the platform 86 is extended through the void in the tray 32, carrying the disk 24 to the removed position 84. Then the conveyor grips 82 are moved toward one another to grasp the disk 24. Finally, the grips 82 are activated to eject the disk 24 from the module 20 to the user. Before another disk 24 is dispensed from the cartridge 34, the grips 82 are moved away from one another and the platform 86 is retracted so that the disk 24 is not deflected between the dispenser 36 and the tray 32.

While the particular module for automatically writing digital data onto a disk dispensed from a stack of disks as herein shown and disclosed in detail is fully capable of obtaining the objects and providing the advantages hereinbefore stated, it is to be understood that it is merely illustrative of the presently preferred embodiments of the invention and that no limitations are intended to the details of the construction or design herein shown other than as described in the appended claims.

What is claimed is:

1. A data transfer module for transferring data onto a disk dispensed from a stack of at least one disk, the data transfer module comprising:
a cartridge for holding the stack of disks;
a dispenser selectively engageable with the stack of disks for sequentially releasing each disk from the cartridge;
a disk-writing drive for receiving each disk released from the cartridge and for writing data thereon to create a written disk; and
a means for ejecting each written disk from the data transfer module.

2. A data transfer module as recited in claim 1 further comprising a port for receiving the data from an external memory device.

3. A data transfer module as recited in claim 1 further comprising a storage device for communicating the data to the disk-writing drive.

4. A data transfer module as recited in claim 1 further comprising:
a port for receiving the data from an external memory device; and
a storage device for holding the data received from the external memory device and for communicating the data to the disk-writing drive.

5. A data transfer module as recited in claim 1 further comprising:
a port for receiving the data from a plurality of external memory devices; and
a storage device for holding the data received from the plurality of external memory devices and for communicating the data to the disk-writing drive.

6. A data transfer module as recited in claim 1 further comprising a disk tray for receiving each disk as each disk is released from the stack of disks in the cartridge and for moving each released disk to the disk-writing drive for writing the data onto each released disk.

7. A data transfer module as recited in claim 6 wherein the means for ejecting comprises:
a transport for transporting each written disk from the disk tray to a removed position;
conveyor grips engageable with each written disk in the removed position; and
a means for activating the grips to eject each written disk from the data transfer module.

8. A data transfer module as recited in claim 7 wherein the transport comprises:
a platform for supporting each written disk;
a shaft having a first end and a second end, with the first end connected to the platform;
a magnetic member connected to the second end of the shaft;
a chamber for receiving the magnetic member therein;
a conductive coil surrounding the chamber; and
a means for passing an electrical current through the coil in a first direction to cause the platform to remove each written disk from the disk tray and to carry each written disk to the removed position, and for passing an electrical current through the coil in a second direction to cause the platform to be retracted away from the removed position.

9. A data transfer module for providing a disk from a stack of at least one disk to a disk-writing drive for transferring data to the disk to create a written disk, the data transfer module comprising:
a cartridge for holding the stack of disks;
a dispenser selectively engageable with the stack of disks for sequentially releasing a disk for transfer from the cartridge to the disk-writing drive; and
an ejector for receiving each written disk from the disk-writing drive and for ejecting the written disk from the data transfer module.

10. A data transfer module as recited in claim 9 wherein the dispenser comprises:
at least one lever for supporting the stack of disks in the cartridge, each lever including a support plate and a retain plate, with each support plate supporting an “n” number of disks in a support orientation, and with each retain plate supporting an “n-i” number of disks in a release orientation; and
a means for simultaneously moving each lever from the support orientation to the release orientation to release one disk from the stack of disks, wherein each lever is subsequently returned to the support orientation after release of the disk.

11. A data transfer module as recited in claim 10 wherein each lever includes cam plates forming the respective support plates and the respective retain plates.

12. A data transfer module as recited in claim 9 wherein the ejector comprises:
a transport for transporting each written disk from the disk-writing drive to a removed position; and
a plurality of conveyor grips engageable with each written disk in the removed position, the grips being activated to eject the written disk from the data transfer module.

13. A data transfer module as recited in claim 12 wherein the transport comprises:
a platform for supporting the disk;
a shaft having a first end and a second end, with the first end connected to the platform;
a magnetic member connected to the second end of the shaft;
a chamber for receiving the magnetic member;
a conductive coil surrounding the chamber; and
a means for passing an electrical current through the coil in a first direction to cause the platform to remove each written disk from the disk tray and to carry each written disk to the removed position, and for passing an electrical current through the coil in a second direction to cause the platform to be retracted away from the removed position.

14. A data transfer module as recited in claim 9 wherein the disks are laser optical disks.

15. A method for automatically writing digital data onto a disk dispensed from a stack of disks to create a written disk, the method comprising the steps of:
positioning the stack of disks in a cartridge connected to a data transfer module; and
activating the data transfer module to sequentially:
dispense each disk from the stack of disks in the cartridge;
write the data onto the dispensed disk; and
eject the written disk from the data transfer module.

16. A method as recited in claim 15 wherein the data transfer module includes a dispenser for sequentially dispensing each disk from the stack of disks, the dispenser having at least one lever for supporting the stack of disks in the cartridge, with each lever including a support plate and a retain plate, wherein each support plate supports an “n” number of disks in a support orientation, and each retain plate supports an “n-I” number of disks in a release orientation, and further wherein each lever moves from the support orientation to the release orientation to release one disk from the stack of disks, with each lever subsequently returning to the support orientation after release of a disk.

17. A method as recited in claim 15 further comprising the sequential steps of:
dispensing a disk from the stack of disks onto a disk tray;
carrying the disk tray with the disk thereon into a disk-writing drive for writing data onto the disk to create a written disk;
withdrawing the disk tray with the written disk thereon from the disk-writing drive; and
removing the written disk from the disk tray to allow the disk tray to receive a next disk.

18. A method as recited in claim 17 wherein an ejector removes each written disk from the disk tray, the ejector comprising:
a transport for transporting each written disk from the disk tray to a removed position; and
a plurality of conveyor grips engageable with each written disk in the removed position, the grips being activated to grasp the written disk to eject the written disk from the data transfer module.

19. A method as recited in claim 18 wherein the transport comprises:
a platform for supporting each written disk;
a shaft having a first end and a second end, with the first end connected to the platform;
a magnetic member connected to the second end of the shaft;
a chamber for receiving the magnetic member therein;
a conductive coil surrounding the chamber; and
a means for passing an electrical current through the coil to cause the platform to remove each written disk from the disk tray and to carry each written disk to the removed position.

20. A method as recited in claim 18 wherein the ejector comprises a pair of conveyor grips and wherein:
the conveyor grips are initially spaced apart by a distance greater than the diameter of each written disk thereby allowing each written disk to be positioned between the conveyor grips; and
the conveyor grips are moved toward each other until the conveyor grips are spaced apart by a distance less than or equal to the diameter of each written disk thereby allowing each written disk to be engaged by the conveyor grips at diametrically opposed locations.
